(19) United States
(12) Patent Application Publication
(10) Pub. No.: US 2004/0183790 A1
(43) Pub. Date: Sep. 23, 2004

(54) Customer order communication apparatus and methods

(76) Inventor: Richard L. Miller, Woodlands, TX (US)

Correspondence Address: Gilbreth & Associates, P.C., P.O. Box 2428, Bellaire, TX, 77402-2428, US

(21) Appl. No.: 10/376,925

(22) Filed: Feb. 27, 2003

(51) Int. Cl. G09G 5/00

(52) U.S. Cl. 345/175

(57) ABSTRACT

A device for taking orders from a drive-thru customer, including a menu board, photoreceptors positioned on the menu board to correspond to menu selections, and a communications link in communication with the photoreceptors and generating a signal indicative of which photoreceptors have received light corresponding to certain menu selections.

### BACKGROUND OF THE INVENTION

1. Field of the Invention

The present invention relates to communication apparatus and methods. In another aspect, the present invention relates to customer order communication apparatus and methods. In even another aspect, the present invention relates to an apparatus having a selection board activated by a customer operated selection device, and methods of communicating orders. In still another aspect, the present invention relates to an apparatus having a selection board with photosensitive receptors activated by a customer pointed laser selection device, and methods of communicating orders.

2. Description of the Related Art

Typical menu boards such as those found at a fast-food restaurant include a microphone and speaker arrangement. The drive-through customer verbally conveys the menu choice to the clerk inside the restaurant, who must then either write down the information and pass it to the chef, or enter it into a computer system that either generates a ticket for the chef, or displays the order to the chef on a display screen. This verbal-based arrangement has many inherent problems.

First, there is noise. Specifically, the ambient noise levels both inside and outside the restaurant make two-way communication extremely difficult and occasionally impossible.

Another problem is low bandwidth. Menu board speakers and microphones must be weather-resistant, which typically means the bandwidth is quite narrow. As a result, customers and clerks have difficulty communicating. This is exacerbated when there are variations in language and dialect between the clerk and the customer.

Even another problem is multiple communication interpretation nodes. Typically, the customer makes a choice and transmits this choice verbally to the clerk (verbal transaction 1). The clerk then interprets and verifies the message (verbal transaction 2), and conveys it to the chef. (verbal transaction 3). Information may be lost or garbled during verbal transaction 1, and since interpretation is based on possibly corrupt input, much time is often spent on the verification procedure (verbal transaction 2) as the customer tells the clerk what he or she wants over and over again.

Still another problem is customers changing their minds or having problems interpreting the menu board. Menu boards that contain new items or new arrangements of once-familiar items may seem complex or confusing to a customer. If so, the resultant verbalization is similarly confusing or vague. Common example: A group of items, say, a double-cheeseburger, large fries, and soft drink may be designated as a “Number 1,” with a fixed price. But the customer may respond this way: “I'd like a number 1, but with no cheese, small fries and a carton of milk.” In short, verbalization allows the customer wide latitude to rearrange the set array of choices. This results in confusion and lost time as the clerk first enters the group (“Number 1” for example), then has to re-enter the information to fit with what the customer actually wants. This problem is compounded by the fact that the customer may be responding only to the perceived confusion of the menu and or the problems in verbal communication.

A number of patents discuss laser pointers, and some have discussed automatically reading a menu list using lasers.

U.S. Pat. No. 5,121,188, issued Jun. 9, 1982 to Partridge et al., discloses a self-contained laser module assembly which, at one end includes a lens positioned to emit a collimated laser beam along the axis of the housing and a second end that includes an electrical contact positioned to contact the power supply. This patent describes the basic configuration of a pen-like laser pointer, including the pocket clip.

U.S. Pat. No. 5,307,253, issued Dec. 9, 1992, discloses a structure of a laser pointer.

U.S. Pat. No. 5,882,106, issued Mar. 16, 1999 to Galli, discloses a thin profile laser pointer assembly.

U.S. Pat. No. 5,957,559 issued Sep. 29, 1999 to Ruch et al., discloses describes a method and apparatus for displaying a menu with a laser projector. While it does describe a device and method that uses a laser to project a menu onto a surface, there is no interaction between laser and menu board.

U.S. Pat. No. 6,097,451, issued Aug. 1, 2000 to Palmer et al., discloses a liquid crystal shutter with low twisted pneumatic liquid crystal-cells driven with a low frequency or DC voltage. Palmer describes a liquid crystal shutter that can be controlled by a low frequency or DC voltage. Similar liquid crystal displays may be found in early digital wristwatches (prior art) driven by low DC voltages.

U.S. Pat. No. 6,295,102 to Higa, et al., discloses a liquid-crystal shutter. This patent discloses use of transparent film substrates that will allow variance of contrast and brightness when liquid crystal displays are used as eyewear shutter devices for 3D computer games. The contrast and brightness can be varied to match the unique parameters of each eye.

U.S. Pat. No. 6,377,167, issued Apr. 23, 2002 to Juds et al., discloses multifrequency photoelectric detection systems. This patent describes a collision avoidance system. The device emits fixed frequency modulated beams and a photoelectric detector array detects reflected light signals. Differences in phase between transmission and reception serve to help determine distance to the object from which light is reflected

U.S. Pat. No. 6,445,437 Miyazaki et al., issued Sep. 3, 2002, discloses a liquid crystal display device.

However, none of the above references disclose using lasers as menu item selection devices, nor using coded pulsed or intermittent lasers as a means of making a selection from a menu board. Additionally, none of the above references discusses using a coded pulsed or intermittent (through the use of liquid crystal shutters) laser beam to identify the customer and verify the laser menu item selection device for use with the menu board or restaurant.

While a few of the above patents disclose liquid crystal shutters, none of the above patents disclose using liquid crystals to produce timed interruptions of the laser beam and thus transmit information based on the sequence of intermittent laser beam pulses over time.

Thus, in spite of the above advancements, there still exists a need in the art for apparatus and methods for communicating customer orders.

There is another need in the art for apparatus and methods for communicating customer orders, which do not suffer from the disadvantages of the prior art apparatus and methods.

There is another need in the art for an apparatus having a selection board activated by a customer operated selection device, and methods of communicating orders.

There is even another need in the art for an apparatus having a selection board with photosensitive receptors activated by a customer pointed laser selection device, and methods of communicating orders.

These and other needs in the art will become apparent to those of skill in the art upon review of this specification, including its drawings and claims.

### SUMMARY OF THE INVENTION

It is an object of the present invention to provide for apparatus and methods for communicating customer orders.

It is another object of the present invention to provide for an apparatus having a selection board activated by a customer operated selection device, and methods of communicating orders.

It is even another object of the present invention to provide for an apparatus having a selection board with photosensitive receptors activated by a customer pointed laser selection device, and methods of communicating orders.

These and other objects of the present invention will become apparent to those of skill in the art upon review of this specification, including its drawings and claims.

According to one embodiment of the present invention, there is provided a device for remotely taking orders from a customer. The device comprises a menu board having a menu selection listing a number of items. For each item of the number of items, there is a photoreceptor associated uniquely to that item, and positioned on the menu board to correspond to that item, and generating a signal when activated by light. The device further includes a communications link in communication with the photoreceptors and generating a signal indicative of which photoreceptors have received light. Alternative embodiments of this invention, include computer hardware systems for carrying out the invention, software implementing various steps of the invention, software storage media embodying the software, and signals embodying the software.

According to another embodiment of the present invention, there is provided a method of remotely taking orders from a customer. The method includes accepting light signals from a customer onto a menu board having photoreceptors uniquely corresponding to menu items. The method further includes generating a signal indicative of which photoreceptors have received light. Alternative embodiments of this invention include computer hardware systems for carrying out the invention, software implementing various steps of the invention, software storage media embodying the software, and signals embodying the software.

According to even another embodiment of the present invention, there is provided a method of placing an order for desired items. The method comprises directing light signals at a menu board onto appropriate photoreceptors corresponding to the desired items. Alternative embodiments of this invention, include computer hardware systems for carrying out the invention, software implementing various steps of the invention, software storage media embodying the software, and signals embodying the software.

### BRIEF DESCRIPTION OF THE DRAWINGS

FIG. 1 is a schematic showing one embodiment of the present invention, in which a customer in vehicle 40 positioned in drive thru order station 4, points laser menu item selection device 5 at menu board 37, such that laser signal 35 strikes surface 30 of menu board 37.

FIG. 2 is a schematic showing an enlarged detailed section of surface 30 of menu board 37, having a number of photoreceptors 25 positioned to correspond to certain menu selections.

FIGS. 3, 4 and 5 are schematics of various embodiments of hand held pointer 5.

### DETAILED DESCRIPTION OF THE INVENTION

According to the present invention, a better way to approach the problem of faulty verbal communication while using menu boards is to supplant the verbal communication with precise choices at the menu board. This can be accomplished by positioning photosensitive receptors beside each menu choice and asking the customer to choose the menu item(s) simply by pointing a laser menu item selection device (such as a specially-modified laser pen) at the menu choice. The photoreceptor cell registers the presence of the laser light and then transmits the data directly (either wireless or by hardwire) to a computer inside the restaurant whereupon the clerk simply reads the menu choice.

Alternatively, as an intermediate step and to allow the customer to change his or her mind, a “final tally” screen will display the choices. Adjacent to the choices will be photoreceptors associated with icons representing [add] or [remove] actions. The customer may choose to add another item by clicking on the appropriate photoreceptor using the hand-held laser menu item selection device. Conversely, the customer may choose to remove an item previously chosen by pointing and clicking on the photoreceptor associated with the appropriate item displayed on the final tally screen. It could be that choices and changes are sent in real time to the computer inside the restaurant, meaning that the restaurant staff sees an evolving selection list, or alternatively, the finalized selections are sent to the computer inside the restaurant, only after “approval” by the customer. While there will be at least one computer utilized (generally inside the restaurant, although it could be positioned at/near the menu board), two computers in communication with each other, one inside the restaurant, and one at/near the menu board, may be utilized.

Referring now to FIG. 1, there is shown one embodiment of the present invention, in which a customer in vehicle 40 positioned in drive thru order station 4, points laser menu item selection device 5 at menu board 37, such that laser signal 35 strikes surface 30 of menu board 37. Menu board provides a menu selection list of a number of items, which list which may be in the form of writing, symbols, and/or pictures.

In an alternative embodiment, optional light blocking panel 42 may be provided to stop light noise 41 from interfering with the operation of menu board 37. One or more light blocking panels 42 may be positioned where desired to stop light noise 41, from for example, car headlights from adjacent roadways or parking lots, direct or reflective sunlight, and the like.

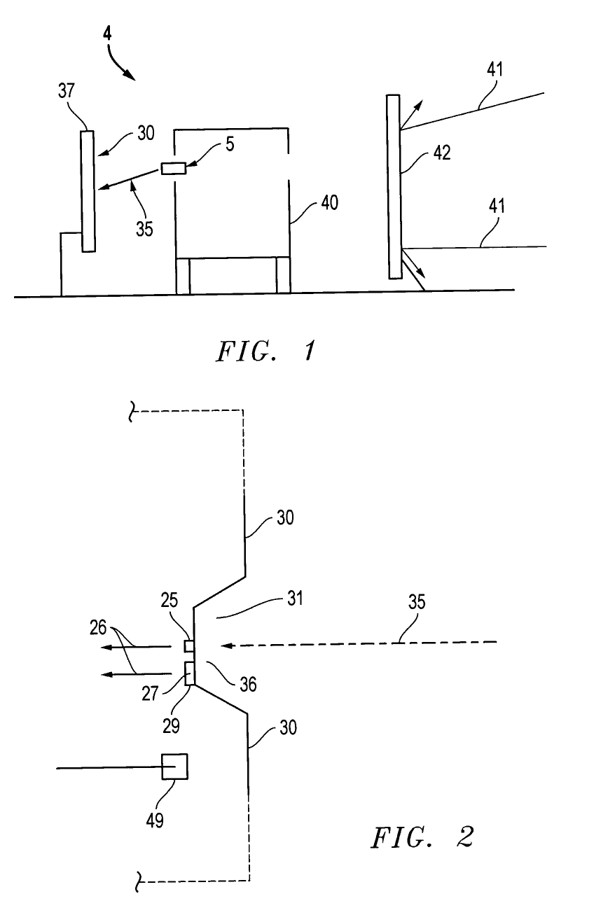

Referring now to FIG. 2, there is shown an enlarged detailed section of surface 30 of menu board 37. A number of photoreceptors 25 are positioned to correspond to certain menu selections. These photoreceptors 25 are optionally positioned in one or more depressions 31 and are optionally covered by weather resistant covers 36 having optical properties that allow transmission of laser beam 35. The coverings 29 of photoreceptors 25 are optionally a weather resistant sound transmissible material. Signals 26 generated from photoreceptors 25 may be transmitted inside the restaurant for further processing, either wireless or hard wire (i.e., wire, cable, or the like). Menu board 37 may optionally be equipped with radio-frequency identification transmitter/receiver 49.

Whereas sound noise is a problem with verbal communication, similarly, light noise can be a problem using a hand-held laser menu item selection device. That problem can be solved by depressing the receptor photocell 25 in a shallow cavity 31 in menu board 37 and by constructing a barrier 42 across from menu board 37. This prevents stray light 41 from directly across the board reaching the photoreceptor and also prevents stray light from the sides reaching the photoreceptors.

The present invention is believed to work with any suitable laser circuit and laser head assembly designed to be used in a hand-held laser pointing device, and not be limited to any particular laser circuit and laser head assembly designed to be used with a hand-held laser pointing device.

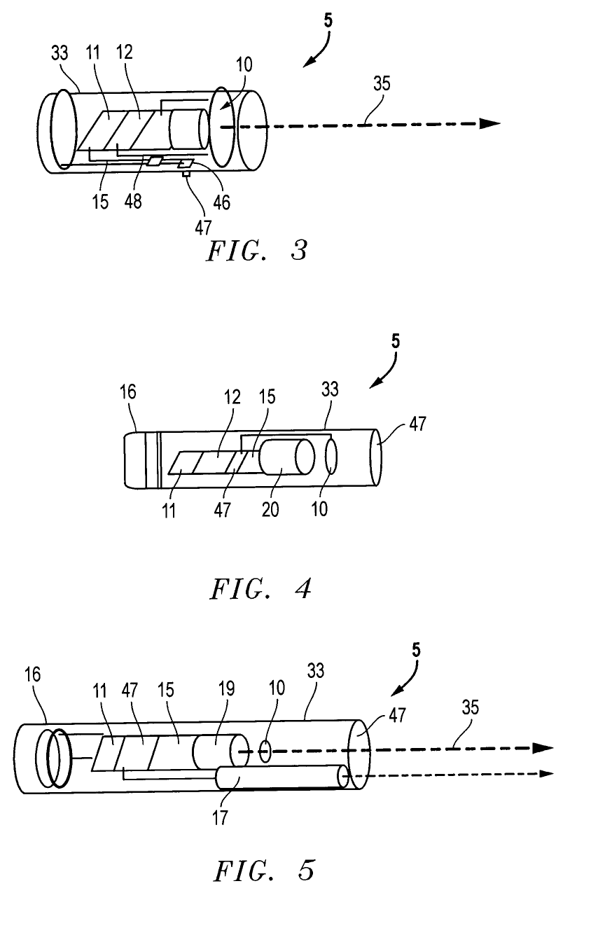

It should be understood that in the practice of the present invention, any suitable light pointing device may be utilized as light pointing device 5. Referring now to FIGS. 3, 4 and 5, there are shown various embodiments of the light pointing device 5 of the present invention. While each of the component parts is not shown in each of FIGS. 3, 4 and 5, light pointing device 5 of the present invention generally includes liquid crystal shutter assembly 10, randomizer circuit 11, pulse train circuit 12, laser circuit 15 including an embedded pulse train circuit, battery 16 (shown as a coin-style battery), an optional high frequency audio signal transmitter 17 as an optional redundant signaling means, recession 19 for laser head to reduce photon noise, laser head 20, an optional radio-frequency transmitter-receiver identification (RFID) chip 46, light-emitting diode 47 and on-off, momentary on-off or two-stage switch as described herein.

As an additional means to reduce noise and spurious signals, the hand-held laser menu item selection device will transmit a coded series of light pulses commensurate with the tolerance of the light receptor(s). In one embodiment, the hand-held laser menu item selection device 5 may be enclosed inside a cylinder 33 with a coin-shaped lithium battery 16 at one end. Inside the cylinder 33, a randomizer circuit 11 and a pulse train circuit 12 are connected to the laser circuit 15 and laser head 20, which is recessed from the front end of the cylinder 33 in recession 19 in order to reduce ambient photon (light) noise.

The advantages of this pulse-train include:

a. As a means of identifying the hand-held device as the preferred device to be used with the menu board. In this embodiment, the menu board will respond only to the hand-held device associated with the restaurant and not to alternative devices such as a standard hand-held pen laser.

b. As a means of identifying the particular customer (user of the hand-held laser menu item selection device). In this embodiment, each laser menu item selection device may be coded by the restaurant for each specific customer. When the customer returns, he or she may elect to choose an item designed to represent the specific item that specific customer generally purchases. Example: “My Usual”. The laser pulse train, is received by the photoreceptor and decoded by the computer downstream from the photoreceptor to provide customer data to the restaurant as well as automatically displaying the menu item that customer usually chooses. Each laser menu item selection device may be coded with credit card, debit card, checking account or other financial information, used for payment of the bill.

c. The hand-held laser menu item selection device may be coded using a randomizing circuit embedded in the device. The circuit, when first used, will produce a one-time randomization process of n numbers, which will then be translated into a series of pulses of varying lengths. After the one-time randomization process, the pulse configuration will be fixed for that device. The device can then be sold or given to the customer after that customer has been identified with that particular pulse train. Other pulse trains may be added to the hand held device as necessary to identify other information. Such information may include but is not limited to: time, date and origin (local restaurant).

In one embodiment, the laser device may optionally be fitted with a radio-frequency identification chip 46 that will detect radio-frequency of a predetermined frequency emitted from the establishment or menu board RFID 49 and respond with a signal that serves to identify the chip and thus the owner of the hand-held laser pointing device. The associated radio-frequency transmitter-receiver in the establishment or menu board (49) may be used as a means to activate the hand-held laser pointer. That is, the laser pointer will not work unless a chip embedded in the hand-held laser pointer receives a signal from the establishment or menu board, at which point the hand-held laser device will become activated and thus can be used to make a selection from the menu board. The data transmitted from the radiofrequency identification chip embedded in the hand-held laser pointer can be used as an additional means to identify the owner of the device. As with the pulse train above, this RFID may contain customer information. It can also be used as a safety device that will prevent the laser device from becoming activated at a location other than at a predetermined distance from the menu board. As a means of allowing the user to know that the hand-held laser device is operating properly, the radio-frequency identification component in the hand-held laser device will be connected to a light-emitting diode or similar visual or audio device mounted on the surface of the hand-held laser pointer. This light-emitting diode or similar signaling device will, upon receiving nearby transmissions from the radio-frequency identification transmitter embedded nearby (in the menu board for example), then glow or otherwise signal that the device is within close proximity to the associated receiver (the menu board). The absence of the transmitter in the menu board will preclude the device from operating. Thus, the laser pointer will only operate in close proximity to the associated menu board.

In an alternative embodiment, the hand-held laser menu selection item may also be fitted with magnetically stored information that is read by a magnetic reader on the reader board. This stored information may include customer information as described above.

In an alternative embodiment, the hand-held laser menu item selection device may be optionally fitted with a small speaker 21 producing sound frequencies above the normal hearing frequency. Sound sources in this frequency range require very small speakers and result in very directional sound patterns. By fitting the photoelectric cell depression(s) 31 in the menu board with microphone(s) 27 responding only to the high-frequency signal associated with the hand-held device, increased accuracy and precision of the pulse train reception can be realized.

a. The audio pulse train can be used commensurate with the laser pulse train (series of coded laser segments). The menu board receptors can be designed to receive either the laser pulse train, the audio pulse train or both.

b. The audio pulse train will project a sound in the high-frequency range and will generally be undetected by human hearing.

c. The audio pulse train (series of segmented or intermittent coded audio signals) may be used when the photoreceptor cell is damaged, or when there is unacceptable photon (light) noise.

d. The speaker for the high frequency audio pulse train will be attached to the same pulse train circuit that drives the laser circuit.

e. Additionally, the high frequency audio speaker will be, like the laser head, recessed from the end of the cylinder in order to increase directionality of the audio signal.

In an alternative embodiment, the laser pulses may be regulated by passing the laser light through a liquid crystal fluid. Rather than having the pulse train circuit drive the laser directly, in the alternative embodiment, the laser light remains constant, but passes through a clear glass or plastic filter housing a liquid crystal shutter assembly. The liquid crystal becomes opaque or clear based upon the induced electrical charge originating in the pulse train circuit. As a result, the laser beam is interrupted sequentially producing the same result as a laser beam projected in a series of dots and dashes of varying lengths. A pattern can be established in such a way that the series of intermittent pulses is recognized by the computer connected with the photoreceptor(s). The established patterns can be translated by the menu board computer into meaningful information such as:

a. confirming that the hand-held laser menu item selection device being used is appropriate for the use intended.

b. confirming that the hand-held laser menu item selection device is owned by a specific customer.

In another embodiment, the laser pointer may be fitted with a button consisting of a two-stage switch in which the first stage activates the laser circuit to assist in aiming, while the second stage activates the pulse train or intermittent signal carrying the information to the photocell on the menu board. In practice, the user depresses and releases the switch on the laser pointer device which activates the laser beam useful for aiming. Once the proper target on the menu board is identified and the laser beam is properly aimed, the user depresses and releases the switch a second time to transmit the information, after which the laser pointer switches off. To make a second selection, the switch is again activated by depressing and releasing the button to produce a continuous beam. When the laser beam is seen on the proper menu board target, the button on the hand held device is depressed and released a second time to transmit the information.

In the preferred embodiment, the hand held laser device will have a momentary push-button switch, however, the pulse train shall be set fast enough that the information would be transmitted within a second of switch activation.

Error-correcting software at the data acquisition site can be used to correct for transmission problems.

### EXAMPLES

a. Once the initial information packet is received, the software will wait a specified amount of time before receiving the next packet. This time period is adjustable, however, it should be equivalent to several seconds. This will preclude accidental triggering of the hand-held laser device and thus incorrect menu choices.

b. A visible or audible feedback mechanism is placed on the Menu Board that will flash or sound when a choice is made. This tells the customer that a choice has been made and the Menu Board is waiting for another transmission.

c. A display attached to the Menu Board and visible to the customer lists the choices as they are made. After a designated period of time, the display asks the customer if that is all the choices, or if the customer would like to change or remove any of the items. The customer may reply using the hand-held laser device pointed at the appropriate receptors on the Menu Board. As described earlier, receptors will be available associated with icons representing [add] or [remove] actions. For example, the customer may aim the hand-held laser pointer to an [add] sign located adjacent to the final tally display to either [add] another item, remove a selected item or agree with the item list and price before driving to the checkout window.

Problems associated with the standard verbal means of communications are completely avoided using the hand-held laser system. Specific benefits include:

a. Inventory control

b. Enhanced communication at the point of choice (the menu board)

c. More accurate orders.

d. Enhanced customer satisfaction. Customers will enjoy perceived control over the entire process from item choice to final tally verification.

e. Customers with securely coded hand-held laser selection devices may choose to point, click and pay through the use of a credit card already on file (though possibly encrypted) with the restaurant or intermediary. Thus a customer can point, click, receive the order and have the purchase securely charged to the customer's credit card.

It is envisioned that the present invention may conveniently be embodied as a computer implemented invention. As such, it is envisioned that the present invention includes any computer hardware and/or software system suitable for carrying out the invention. Various features of the invention may be embodied in software, with such software resident on storage media or such software may be transmitted in a signal.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which this invention pertains.

I claim:

1. A system for remotely taking orders from a customer, the device comprising:
a menu board having a menu selection listing a number of items;
for each item of the number of items, a photoreceptor associated uniquely to that item, and positioned on the menu board to correspond to that item, and generating a signal when activated by light;
communications link in communication with the photoreceptors and generating a signal indicative of which photoreceptors have received light.

2. The system of claim 1, further comprising a radio-frequency identification transmitter/receiver.

3. The system of claim 1, further comprising:
for each item of the number of items, an audio receptor associated uniquely to that item, and positioned on the menu board to correspond to that item, and generating a signal when activated by sound;
communications link in communication with the audio receptors and generating a signal indicative of which audio receptors have received sound.

4. The system of claim 1, further comprising a light emitting selection device remotely positioned from the menu board, and emitting a light having characteristics suitable for activating the photoreceptors.

5. A method of remotely taking orders from a customer, the method comprising:
(A) accepting light signals from a customer onto a menu board having photoreceptors uniquely corresponding to menu items; and
(B) generating an order signal indicative of which photoreceptors have received light.

6. The method of claim 5, wherein in step (A), the customer is positioned within a vehicle positioned near the menu board.

7. The method of claim 5, further comprising filling an order based on the order signal.

8. The method of claim 5, wherein step (A) further includes accepting customer information from the customer in the form of magnetic, light or radio signals.

9. A method of placing an order for desired items, the method comprising:
(A) directing light signals at a menu board and activating appropriate photoreceptors corresponding to the desired items.

10. The method of claim 9, further comprising, prior to step (A) positioning a vehicle near a menu board, and wherein step (A) is carried out from within the vehicle.
